(19) United States
(12) Patent Application Publication
(10) Pub. No.: US 2024/0232056 A1
(43) Pub. Date: Jul. 11, 2024

(54) A Concept for Generating a Test Specification

(71) Applicant: Intel Corporation, Santa Clara, CA (US)

(72) Inventors: Junjun SHAN, Shanghai (CN); Yi QIAN, Shanghai (CN); Xiangyang WU, Shanghai (CN); Qian OUYANG, Shanghai (CN); Minggui CAO, Shanghai (CN); Junjie MAO, Shanghai (CN); Jian Jun CHEN, Shanghai (CN)

(21) Appl. No.: 18/571,797

(22) PCT Filed: Oct. 15, 2021
(86) PCT No.: PCT/CN2021/124209

§ 371 Date: Dec. 19, 2023

(51) Int. Cl. G06F 11/36

(52) U.S. Cl. CPC G06F 11/3676; G06F 11/3684

(57) ABSTRACT

Examples relate to an apparatus, a device, a method, and a computer program for generating a test specification for testing software code of a function under test. The apparatus for generating the test specification for testing software code of a function under test comprises circuitry configured to extract a plurality of symbols from the software code of the function under test, generate a plurality of test vectors with corresponding sets of expected results for the function under test based on the plurality of symbols, and generate a test specification based on the plurality of test vectors and the corresponding sets of expected results.

### FIELD

Examples relate to an apparatus, a device, a method, and a computer program for generating a test specification for testing software code of a function under test.

### BACKGROUND

A FUSA (Functional Safety) capability is of high value in industrial and automotive fields for WLC (workload consolidation). For safety-critical software, unit tests are often used to prove FUSA capability. Moreover, unit tests may be used to achieve that entry points, statements, and branch coverage are compliant with Safety Integrity Level (SIL) 3 requirement (SIL 3 Capable, SC3). In many cases, the effort required for writing the unit tests consumes a lot of resources, with the task of developing and implementing these test cases being a difficult tasks.

In the industry, some commercial tools, such as LDRA (Liverpool Data Research Associated), are used to create unit tests, which may address some of the effort required. However, LDRA runs in user mode in ring 3, so it is not applicable for basic software such as operation systems and hypervisors, which will run in ring 0 and use privileged instructions. In such cases, extra manual work may be required.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for generating a test specification for testing software code of a function under test;

FIG. 1b shows a flow chart of an example of a method for generating a test specification for testing software code of a function under test;

FIG. 2 shows a flow chart of an example of a flow of a code coverage advisor; and

FIG. 3 shows a table of an example of a schema of a test case.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/example,” “some embodiments/example,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/example,” “in some embodiments/examples,” and/or “in various embodiments/examples,” each of which may refer to one or more of the same or different embodiments or examples. Furthermore, the terms “comprising,” “including,” “having,” and the like, as used with respect to embodiments of the present disclosure, are synonymous.

Various examples of the present disclosure relate to a concept (e.g., a method) for unit test automation, which may, in some examples, be used to achieve the FUSA requirements. The proposed concept may provide a method to automatically generate and perform software unit test, e.g. with the aim of achieving entry points, statements, branches, and conditions coverage of 100%.

The proposed approach provides a lightweight method which may generate and perform software unit tests, e.g., to achieve FUSA requirements. The proposed approach was evaluated in the context of a hypervisor, with an approximate 50% reduction of the workload with respect to unit tests. Various examples of the present disclosure may be customized to a desired coverage, identify the missing code (for coverage), and provide a proposal on how to improve the code coverage for the user. The proposed concept may be used in software and may help users that are not familiar with basic software, such as a hypervisor and an operation system, to reduce workload to achieve FUSA (functional safety) requirements.

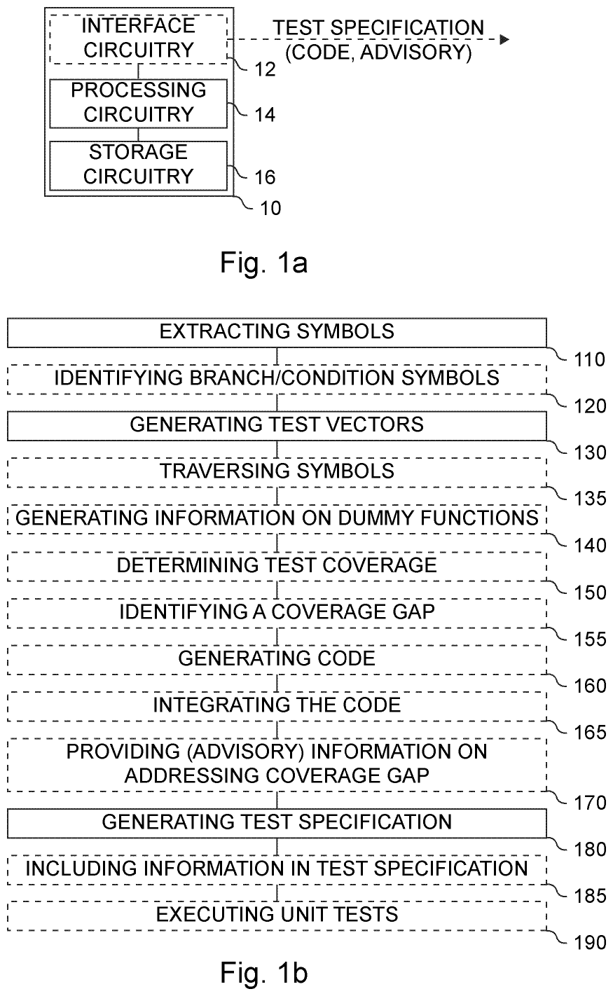

FIG. 1a shows a block diagram of an example of an apparatus 10 or device 10 for generating a test specification for testing software code of a function under test. The apparatus 10 comprises circuitry, configured to provide the functionality of the apparatus 10. For example, the apparatus 10 may comprise (optional) interface circuitry 12, processing circuitry 14 and storage circuitry 16. For example, the processing circuitry 14 may be coupled with the interface circuitry 12 and with the storage circuitry 16. For example, the processing circuitry 14 may be configured to provide the functionality of the apparatus 10, in conjunction with the interface circuitry 12 (for exchanging information, e.g. for providing information, such as information on a test specification, information for addressing a coverage gap, code etc., or for receiving information on the software code) and the storage circuitry 16 (for storing information). Likewise, the device 10 may comprise means that is/are configured to provide the functionality of the device 10. The components of the device 10 are defined as component means, which may correspond to, or implemented by, the respective structural components of the apparatus 10. For example, the device 10 may comprise means for processing 14, which may correspond to or be implemented by the processing circuitry 14, means for communicating 12, which may correspond to or be implemented by the interface circuitry 12, and means for storing information 16, which may correspond to or be implemented by the storage circuitry 16.

The circuitry/means is configured to extract a plurality of symbols from the software code of the function under test. The circuitry/means is configured to generate a plurality of test vectors with corresponding sets of expected results for the function under test based on the plurality of symbols. The circuitry/means is configured to generate a test specification based on the plurality of test vectors and the corresponding sets of expected results.

FIG. 1b shows a flow chart of an example of a corresponding method for generating the test specification for testing the software code of the function under test. The method comprises extracting 110 the plurality of symbols from the software code of the function under test. The method comprises generating 130 the plurality of test vectors with corresponding sets of expected results for the function under test based on the plurality of symbols. The method comprises generating 180 the test specification based on the plurality of test vectors and the corresponding sets of expected results.

In the following, the functionality of the apparatus 10, the device 10, the method and of a corresponding computer program is introduced in connection with the apparatus 10. Features introduced in connection with the apparatus 10 may be likewise included in the corresponding device 10, method and computer program.

The proposed concept relates to an apparatus 10, device 10, method and computer program for generating a test specification for testing software code of a function under test. In particular, the proposed concept may be used to generate a test specification that can be used to generate so-called unit tests for testing the function under test. Moreover, the software code of the function under test may be software code of a function of a software component that is part of a basic software, i.e., software that is executed in kernel space, with access to privileged operations not available to user space software components.

In general, unit tests are software-defined tests that are used to test whether a function under test behaves as expected. The function under test is usually parametrized, e.g., by setting one or more input parameters or by setting one or more global variables, and an expected result with respect to the one or more input parameters and/or one or more global variables, is defined. The unit test then executes the function under test, and checks whether the behavior of the function under test matches the expected result, e.g., with respect to a return value, with respect to (sub-) functions being called, with respect to global memory being impacted etc. In particular, unit tests that are used to test basic software may clearly define the expected results, also with respect to global memory and functions being called, as such basic software may directly access hardware functionality, in addition to other functions of the operating system/hypervisor, which may increase the complexity of generating such unit tests.

As outlined above, the proposed concept may be used to generate test cases for software code being used in software components that is part of basic software, i.e. software that is executed in kernel space, with access to privileged operations not available to user space software components. In other words, the software code of the function under test may be software code to be executed in kernel space. For example, the software code of the function under test may be software code to access hardware functionality of a computer. For example, the software code of the function under test may be software code of a hypervisor or of a kernel or kernel-space component of an operating system. For example, the software code of the function under test may access one or more privileged instructions, i.e., one or more instructions that are inaccessible to user space applications. For example, to circumvent such inaccessibility in the generation of the test cases, a static analysis approach may be used, which abstracts the access to the privileged instructions using one or more dummy functions, in combination with a modeling of the impact of the function on global memory.

The circuitry is configured to extract the plurality of symbols from the software code of the function under test. In general, the symbols may be seen as basic building blocks of the function under test. Symbols may include one or more of the group of functions, local variables, global variables, loops, conditional/branch statements etc. For example, a compiler being used to compile the software code of the function under test may collect the symbols of the function under test in a so-called symbol table. Accordingly, the plurality of symbols may be extracted from an output, such as a symbol table, of a compiler being used for compiling the software code of the function under test.

In general, software code comprises a list of programming statements that are to be executed in the order defined by the software code. In some cases, however, not every statement is to be executed, because one or more of the programming statements are only to be executed if a certain pre-condition is met. Such cases are defined using so-called “branch statements” and “condition statements”, which lead to corresponding “branch symbols” and “condition symbols”. For example, a branch statement may correspond to a “case” statement in the software code, or to a cascade of “if” statements covering different cases. A condition statement may correspond to an “if” (or similar) statement in the software code. These cases are of particular interest with respect to test coverage, as the different branches being opened by the branch statements and condition statements are often handled separately, as separate unit test cases. Accordingly, the circuitry may be configured to identify one or more branch symbols and one or more condition symbols among the plurality of symbols. The circuitry may be configured to generate the plurality of test vectors based on branching outcomes of the one or more branch symbols and/or based on condition outcomes of the one or more condition symbols. Accordingly, the method may comprise identifying 120 one or more branch symbols and one or more condition symbols among the plurality of symbols and generating 130 the plurality of test vectors based on the branching outcomes of the one or more branch symbols and/or based on the condition outcomes of the one or more condition symbols. For example, for each branching outcome (e.g., for each case) or condition outcome (e.g., condition fulfilled and condition not fulfilled), a separate test vector may be generated. Moreover, for each combination (e.g., member of the cartesian product) of branching outcomes or condition outcomes, a separate test vector may be generated.

The circuitry is configured to generate the plurality of test vectors with corresponding sets of expected results for the function under test based on the plurality of symbols. This may be done recursively. For example, the symbols may be traversed recursively. If the function under test calls another function (that is part of the software code), a separate test vector may be created for this function in isolation, in addition to the test vector comprising the function in the context of the function under test. Moreover, if a branch symbol or condition symbol is detected, separate test vectors may be created for each branching outcome/condition outcome, and the respective branching outcomes/condition outcomes may be recursively processed to create additional test vectors (in case the branching outcome/condition outcome comprises another branch symbol or condition symbol). In other words, the circuitry may be configured to recursively traverse the symbols of the plurality of symbols to generate the plurality of test vectors. Accordingly, the method may comprise recursively traversing 135 the symbols of the plurality of symbols to generate the plurality of test vectors. In other words, for each function (of the software code) being called, branch identified or conditional statement identified, the respective function being called, branch and conditional section may be processed recursively to identify the relevant test vectors. For example, the recursive processing may be used for further analysis, e.g., with respect to branch coverage.

For each test vector, a set of expected results is generated, which models the behavior of the function under test. In other words, each test vector is associated with a set of expected results, which defines the expected behavior of the function under test with respect to the test vector. For example, if the test vector relates to one branch taken at a branch statement, the set of expected results defines the behavior that is expected when that one branch is taken by the function under test. There are various aspects to the expected results. For example, each set of expected results may comprise one or more of an expected invocation of one or more functions, an expected memory layout, an expected return value of the function under test, and an expected impact of the function under test on global memory or an external resource. For example, the expected invocation of one or more functions may define one or more functions, and an order between these one or more functions, that are to be called by the function under test (including parameter values and return values, if applicable) in the test vector. For example, the expected memory layout may define local variables and/or local memory structures that are to be set and accessed by the function under test in the test vector. In other words, the expected memory layout may be based on one or more local variables and/or memory structures included in the software code. For example, the expected return value of the function under test may define, which value the function under test is expected to return in the test vector. For example, the expected impact of the function under test on the global memory or the external resource may define an impact of the function under test on the global memory (e.g., on global variables or global memory structures) and/or on the external resource (e.g., on a memory or state of a hardware device).

As outlined above, the set of expected results may include an expected invocation of one or more functions. To make these functions independent of the machine, environment or user space/kernel space being used to run the eventual test cases, the one or more functions may be abstracted and included in the set of expected results, and eventually in the test specification. For example, the one or more functions to be invoked by the function under test may be replaced by so-called dummy functions (also “mock functions”), which are functions that provide a pre-defined result for the set of parameters/global variables being set within the test vector/test case. In other words, each dummy function may represent a function being invoked by the function under test, by providing the return value and/or having an expected impact on global memory or an external resource that the function being invoked is expected to have in the test case. The circuitry may be configured to generate information on one or more dummy functions representing the one or more functions. Accordingly, the method may comprise generating 140 the information on one or more dummy functions representing the one or more functions. For example, the information on the one or more dummy functions may comprise information on the return value and the expected impact on global memory or an external resource of the respective one or more dummy functions.

Moreover, if more than one dummy function is generated, the information on the one or more dummy functions may comprise information on a sequence of invocation of the dummy functions. In other words, information on the expected sequence of invocations of the one or more functions, and therefore also of the one or more dummy functions, may be included in the set of expected results and/or in the test specification.

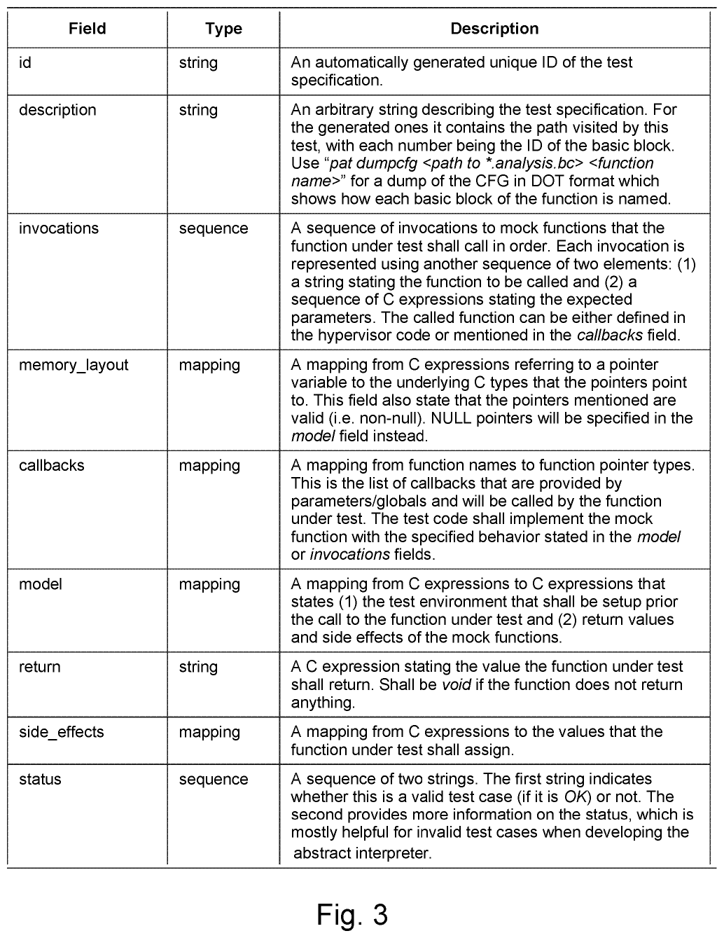

These test vectors and expected results are now used to compile the test specification. In other words, the circuitry is configured to generate the test specification based on the plurality of test vectors and the corresponding sets of expected results. For example, the test specification may comprise information on a plurality of test cases representing the plurality of test vectors. For example, each test case (and therefore each test vector) may be identified by an identifier and may comprise information on the set of expected results (and thus the expected behavior) of the function under test in the test case. For example, an example of a test case, as defined in YAML (Yet Another Markup Language), can be found in FIG. 3. For example, the test case may comprise one or more of the fields “id” (identifier), “description” (a string describing the test specification), “invocations” (i.e., which function(s) are being invoked by the function under test, and dummy functions for modeling these function(s), e.g., the information on the one or more dummy functions), “memory_layout” (i.e., the information on the expected memory layout), “callbacks” (i.e., the parameters and/or global variables defining the test case), “model” (e.g., the test environment being set and return values and side effects of the dummy functions), “return” (i.e., the expected return value), “side_effects” (i.e., the information on the expected impact of the function under test on the global memory or the external resource in the test specification) and “status” (e.g., an indicator that the test case is valid, and information on a status of the test case). In other words, the circuitry may be configured to include one or more of information on one or more dummy functions representing the one or more functions, information on the expected memory layout, information on the expected return value of the function under test, and information on the expected impact of the function under test on the global memory or the external resource in the test specification. In other words, the method may comprises including 185 one or more of the information on the one or more dummy functions representing the one or more functions, the information on the expected memory layout, the information on the expected return value of the function under test, and the information on the expected impact of the function under test on the global memory or the external resource in the test specification.

In general, the proposed concept is used to generate a test specification, which can then be transferred into corresponding unit tests. In some cases, however, such automatic unit test generation may be infeasible, e.g., as some branches or conditions are never reached when the function under test is executed, or as the expected set of results cannot be compiled as the behavior of an external resource (e.g., a hardware device) is unknown to the proposed algorithm. Therefore, some or all expected results and/or test cases may be (at least partially) defined manually. However, as long as the test cases do not cover all of the branches, a so-called “coverage gap” persists, which may be undesired if the tests are performed to conform with a certification standard, such as FUSA. For example, the circuitry may be configured to determine a test coverage of the plurality of test vectors while traversing the symbols, and to identify a coverage gap in the test coverage. Accordingly, the method may comprise determining 150 a test coverage of the plurality of test vectors while traversing the symbols and identifying 155 a coverage gap in the test coverage. For example, the test coverage may be determined by determining, for each test vector, whether a test case exists that covers the test vector. In other words, if a test case exists that can be used to test a test vector, the test vector may be considered covered. For example, identifying the coverage gap may comprise identifying a subset of test vectors that are not covered by a (or any) test case.

This coverage gap may be addressed by the proposed concept. For example, in some (or many) cases, test cases may be generated automatically to address the gap of the test coverage. In other words, the circuitry may be configured to generate code (e.g., test code) for addressing the gap of the test coverage and to integrate the code for addressing the gap of the test coverage in the software code. Accordingly, the method may comprise generating 160 the code for addressing the gap of the test coverage and integrating 165 the code for addressing the gap of the test coverage in the software code. For example, the software code may comprise a section comprising the test cases (e.g., unit tests) for testing the function under test. The code for addressing the gap of the test cases may be included, e.g., as unit tests, within the section comprising the test cases. For example, the test specification, e.g., the parameters and/or global variables defining the test case and the set of expected results (including the dummy functions) may be used to generate the code. In other words, the test specification may comprise a specification of a plurality of unit tests that are based on the plurality of test vectors and the plurality of expected results. The circuitry may be configured to generate code for the plurality of unit tests based on the specification of a plurality of unit tests included in the test specification. For example, the set of expected results may be used to defined so-called “assertion” statements of the respective test cases, and the parameters and/or global variables defining the test case may be used to set up the respective test cases. The dummy functions may be used to replace the “real” function calls in the test cases. The resulting code of the unit tests may be included within the section of the software code comprising the test cases.

Not every test case may be suitable for automatic code generation. For example, some portions of the code might never be reached, some branches may be mutually exclusive etc., such that suitable parameters and/or global variables defining the test case might not exist (i.e., there might not be a combination of parameters and/or global variables that can be used to enter a branch being identified as a test vector). In this case, the proposed concept may assist the user with an advisory functionality to address the coverage gap.

For example, if a branch cannot be reached by a test case, two measures can be taken—the test coverage may be customized to exclude the branch, or the software code of the function under test may be changed so the branch can be reached. In both cases, the proposed concept may provide assistance. For example, the circuitry may be configured to provide information for addressing the gap of the test coverage in the software code or by customizing the coverage. In other words, the method may comprise providing 170 information for addressing the gap of the test coverage in the software code or by customizing the coverage. In particular, the circuitry may be configured to provide the information for addressing the gap of the test coverage as part of a code advisor for guiding a user on how to address the gap of the test coverage. For example, the circuitry may be configured to provide information on one or more branches and/or conditions that are never entered in the function under test. For example, the circuitry may be configured to provide a user interface (e.g., in an integrated development environment, IDE) showing the one or more branches and/or conditions that are never entered in the function under test. The user interface may include information on one or more courses of action for addressing the gap of the test coverage, e.g., a course of action related to excluding the respective branch and/or condition from the determination of the test coverage (by customizing the test coverage) and/or a course of action related to code of the function under test, with the code being suitable for eliminating the respective branch(es) and/or conditional(s). For example, the one or more courses of action may be provided based on guidelines for good software practice. The one or more courses of actions may be provided as part of a code advisor (e.g., in the IDE), which may be consulted by the user being tasked with generating the test cases.

As has been outlined before, a result of the proposed concept may be the test cases, which may be derived from the test specification (by generating the respective test cases) and/or manually specified by the user. For example, the test cases may be defined as unit tests, and be included in a section of the software code. The unit tests may be executed (automatically) when the software code is changed, e.g., automatically upon compilation, manually (initiated by the user), or automatically within a continuous integration framework. Accordingly, the circuitry may be configured to execute unit tests corresponding to the plurality of test vectors based on the test specification. Accordingly, the method may comprise executing 190 unit tests corresponding to the plurality of test vectors based on the test specification. For example, the unit tests may comprise at least one unit test that is automatically generated from the test specification and/or at least one unit test that is manually generated based on the information for addressing the gap of the test coverage in the software code.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

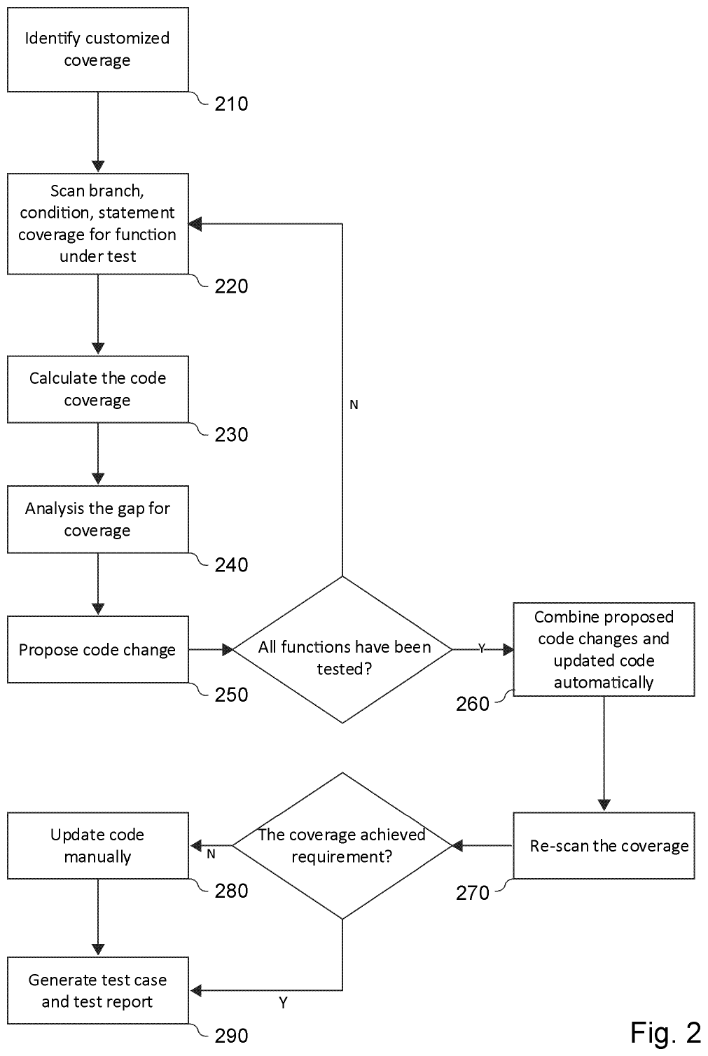

More details and aspects of the apparatus 10, device 10, method and computer program are mentioned in connection with the proposed concept or one or more examples described above or below (e.g. FIG. 2 or 3). The apparatus 10, device 10, method and computer program may comprise one or more additional optional features corresponding to one or more aspects of the proposed concept or one or more examples described above or below.

In the following, a detailed example of the proposed concept is shown.

In the proposed concept, the source code is analyzed to generate a unit tests specification with a semi-formal notation. Then, test cases can be created easily and automatically. A summary of the concept and procedure are described as below. For example, the proposed concept may comprise one or more of the following tasks: (1) Analyze the software code (e.g., in C language) to abstract the symbols. (2) Generate and execute test vectors from these symbols under all effects to get the expected results which may include invocation, memory layout, return value, side effect and other status. (3) Generate test specification, e.g., in the YAML (Yet Another Markup Language) format (see the table of FIG. 3) from these semi-formal test vectors. (4) Import the test specification to generate the test cases. (5) Execute the test cases and export the test results in a final report to collect the branch related coverage for each function and total test case pass rate. (6) After analysis of the test result, the code flaw places may be pointed out in a code advisor and some suggestions based on good software practice to improve the coverage and resolve bugs may guide the code update of the component under test. A more detailed coverage of the code advisor is provided in connection with FIG. 2.

FIG. 2 shows a flow chart of an example of a flow of a code coverage advisor. The flow chart starts with the task of identifying a customized coverage (210), followed by the task of scanning branch, condition, statement coverage for the function under test (220). This is flowed by calculating the code coverage (230), and analysis of a gap in the coverage (240). Based on the gap in the coverage, a code change is proposed (250). The flow chart then returns to (220) to (recursively) scan the next function under test. If all functions have been tested, the proposed code changes are combined and the code is updated automatically (250). Subsequently, the coverage is re-scanned. If the coverage does not achieve the requirement, the code may be updated manually (280), and the test cases and test report is provided (290). If the coverage achieves the requirement, the test cases and test report is provided (290) directly.

FIG. 3 shows a table of an example of a schema of a test case (in the YAML) format. The test case may comprise one or more of the following fields.

The test case may comprise the field “id” of type “string”, which may be an automatically generated unique ID of the test specification. The test case may comprise the field “description” of type “string”, which may be an arbitrary string describing the test specification. For the generated ones it may contain the path visited by this test, with each number being the ID of the basic block. “pat dumpcfg <path to *.analysis.bc> <function name>” may be used for a dump of the CFG in DOT format which shows how each basic block of the function is named.

The test case may comprise the field “invocations” of type “sequence”, which may comprise a sequence of invocations to mock functions that the function under test shall call in order. Each invocation may be represented using another sequence of two elements: (1) a string stating the function to be called and (2) a sequence of C expressions stating the expected parameters. The called function may be (either) defined in the hypervisor code or mentioned in the callbacks field.

The test case may comprise the field “memory_layout” of type “mapping”, which may comprise a mapping from C expressions referring to a pointer variable to the underlying C types that the pointers point to. This field may also state that the pointers mentioned are valid (i.e. non-null). NULL pointers may be specified in the model field instead.

The test case may comprise the field “callbacks” of type “mapping”, which may comprise a mapping from function names to function pointer types. This may comprise the list of callbacks that are provided by parameters/globals and may be called by the function under test. The test code shall implement the mock function with the specified behavior stated in the model or invocations fields.

The test case may comprise the field “model” of type “mapping”, which may comprise a mapping from C expressions to C expressions that states (1) the test environment that shall be setup prior the call to the function under test and (2) return values and side effects of the mock functions.

The test case may comprise the field “return” of type “string”, which may comprise a C expression stating the value the function under test shall return. It may be void if the function does not return anything.

The test case may comprise the field “side_effects” of type “mapping”, which may comprise a mapping from C expressions to the values that the function under test shall assign.

The test case may comprise the field “status” of type “sequence”, which may comprise a sequence of two strings. The first string may indicate whether this is a valid test case (if it is OK) or not. The second may provide more information on the status, which is mostly helpful for invalid test cases when developing the abstract interpreter.

This proposed concept proposes a novel method to automatically generate and perform software unit tests to achieve entry points, statements, branches, and conditions coverage of 100% (or a customized coverage) with an automatic code advisor. It may reduce the verification and design workload and improve the quality of software in industrial and opensource project both inside and outside of a company, especially to help customer to reduce effort to achieve FUSA requirements.

More details and aspects of the proposed concept for generating test cases are mentioned in connection with the proposed concept or one or more examples described above or below (e.g. FIG. 1a to 1b). The proposed concept for generating test cases may comprise one or more additional optional features corresponding to one or more aspects of the proposed concept or one or more examples described above or below.

In the following, some examples of the proposed concept are given.

An example (e.g., example 1) relates to an apparatus (10) for generating a test specification for testing software code of a function under test, the apparatus comprising circuitry configured to extract a plurality of symbols from the software code of the function under test. The circuitry is configured to generate a plurality of test vectors with corresponding sets of expected results for the function under test based on the plurality of symbols. The circuitry is configured to generate a test specification based on the plurality of test vectors and the corresponding sets of expected results.

Another example (e.g., example 2) relates to a previously described example (e.g., example 1) or to any of the examples described herein, further comprising that the circuitry is configured to identify one or more branch symbols and one or more condition symbols among the plurality of symbols, and to generate the plurality of test vectors based on branching outcomes of the one or more branch symbols and/or based on condition outcomes of the one or more condition symbols.

Another example (e.g., example 3) relates to a previously described example (e.g., one of the examples 1 to 2) or to any of the examples described herein, further comprising that the plurality of symbols are extracted from an output of a compiler for compiling the software code of the function under test.

Another example (e.g., example 4) relates to a previously described example (e.g., one of the examples 1 to 3) or to any of the examples described herein, further comprising that each set of expected results comprises one or more of an expected invocation of one or more functions, an expected memory layout, an expected return value of the function under test, and an expected impact of the function under test on global memory or an external resource.

Another example (e.g., example 5) relates to a previously described example (e.g., example 4) or to any of the examples described herein, further comprising that the circuitry is configured to include one or more of information on one or more dummy functions representing the one or more functions, information on the expected memory layout, information on the expected return value of the function under test, and information on the expected impact of the function under test on the global memory or the external resource in the test specification.

Another example (e.g., example 6) relates to a previously described example (e.g., one of the examples 4 to 5) or to any of the examples described herein, further comprising that the expected memory layout is based on one or more local variables and/or memory structures included in the software code.

Another example (e.g., example 7) relates to a previously described example (e.g., one of the examples 1 to 6) or to any of the examples described herein, further comprising that each set of expected results comprises an expected invocation of one or more functions, wherein the circuitry is configured to generate information on one or more dummy functions representing the one or more functions, the information on the one or more dummy functions comprising information on a return value and an expected impact on global memory or an external resource of the respective one or more dummy functions and, if more than one dummy function is generated, information on a sequence of invocation of the dummy functions, and to include the information on the one or more dummy functions in the test specification.

Another example (e.g., example 8) relates to a previously described example (e.g., one of the examples 1 to 7) or to any of the examples described herein, further comprising that the test specification comprises a specification of a plurality of unit tests that are based on the plurality of test vectors and the plurality of expected results.

Another example (e.g., example 9) relates to a previously described example (e.g., one of the examples 1 to 8) or to any of the examples described herein, further comprising that the circuitry is configured to recursively traverse the symbols of the plurality of symbols to generate the plurality of test vectors.

Another example (e.g., example 10) relates to a previously described example (e.g., example 9) or to any of the examples described herein, further comprising that the circuitry is configured to determine a test coverage of the plurality of test vectors while traversing the symbols, and to identify a coverage gap in the test coverage.

Another example (e.g., example 11) relates to a previously described example (e.g., example 10) or to any of the examples described herein, further comprising that the circuitry is configured to generate code for addressing the gap of the test coverage and to integrate the code for addressing the gap of the test coverage in the software code.

Another example (e.g., example 12) relates to a previously described example (e.g., example 10) or to any of the examples described herein, further comprising that the circuitry is configured to provide information for addressing the gap of the test coverage in the software code or by customizing the coverage.

Another example (e.g., example 13) relates to a previously described example (e.g., example 12) or to any of the examples described herein, further comprising that the circuitry is configured to provide the information for addressing the gap of the test coverage as part of a code advisor for guiding a user on how to address the gap of the test coverage.

Another example (e.g., example 14) relates to a previously described example (e.g., one of the examples 1 to 13) or to any of the examples described herein, further comprising that the circuitry is configured to execute unit tests corresponding to the plurality of test vectors based on the test specification.

An example (e.g., example 15) relates to a device (10) for generating a test specification for testing software code of a function under test, the device comprising means configured to extract a plurality of symbols from the software code of the function under test. The means is configured to generate a plurality of test vectors with corresponding sets of expected results for the function under test based on the plurality of symbols. The means is configured to generate a test specification based on the plurality of test vectors and the corresponding sets of expected results.

Another example (e.g., example 16) relates to a previously described example (e.g., example 15) or to any of the examples described herein, further comprising that the means is configured to identify one or more branch symbols and one or more condition symbols among the plurality of symbols, and to generate the plurality of test vectors based on branching outcomes of the one or more branch symbols and/or based on condition outcomes of the one or more condition symbols.

Another example (e.g., example 17) relates to a previously described example (e.g., one of the examples 15 to 16) or to any of the examples described herein, further comprising that the plurality of symbols are extracted from an output of a compiler for compiling the software code of the function under test.

Another example (e.g., example 18) relates to a previously described example (e.g., one of the examples 15 to 17) or to any of the examples described herein, further comprising that each set of expected results comprises one or more of an expected invocation of one or more functions, an expected memory layout, an expected return value of the function under test, and an expected impact of the function under test on global memory or an external resource.

Another example (e.g., example 19) relates to a previously described example (e.g., example 18) or to any of the examples described herein, further comprising that the means is configured to include one or more of information on one or more dummy functions representing the one or more functions, information on the expected memory layout, information on the expected return value of the function under test, and information on the expected impact of the function under test on the global memory or the external resource in the test specification.

Another example (e.g., example 20) relates to a previously described example (e.g., one of the examples 18 to 19) or to any of the examples described herein, further comprising that the expected memory layout is based on one or more local variables and/or memory structures included in the software code.

Another example (e.g., example 21) relates to a previously described example (e.g., one of the examples 15 to 20) or to any of the examples described herein, further comprising that each set of expected results comprises an expected invocation of one or more functions, wherein the means is configured to generate information on one or more dummy functions representing the one or more functions, the information on the one or more dummy functions comprising information on a return value and an expected impact on global memory or an external resource of the respective one or more dummy functions and, if more than one dummy function is generated, information on a sequence of invocation of the dummy functions, and to include the information on the one or more dummy functions in the test specification.

Another example (e.g., example 22) relates to a previously described example (e.g., one of the examples 15 to 21) or to any of the examples described herein, further comprising that the test specification comprises a specification of a plurality of unit tests that are based on the plurality of test vectors and the plurality of expected results.

Another example (e.g., example 23) relates to a previously described example (e.g., one of the examples 15 to 22) or to any of the examples described herein, further comprising that the means is configured to recursively traverse the symbols of the plurality of symbols to generate the plurality of test vectors.

Another example (e.g., example 24) relates to a previously described example (e.g., example 23) or to any of the examples described herein, further comprising that the means is configured to determine a test coverage of the plurality of test vectors while traversing the symbols, and to identify a coverage gap in the test coverage.

Another example (e.g., example 25) relates to a previously described example (e.g., example 24) or to any of the examples described herein, further comprising that the means is configured to generate code for addressing the gap of the test coverage and to integrate the code for addressing the gap of the test coverage in the software code.

Another example (e.g., example 26) relates to a previously described example (e.g., example 24) or to any of the examples described herein, further comprising that the means is configured to provide information for addressing the gap of the test coverage in the software code or by customizing the coverage.

Another example (e.g., example 27) relates to a previously described example (e.g., example 26) or to any of the examples described herein, further comprising that the means is configured to provide the information for addressing the gap of the test coverage as part of a code advisor for guiding a user on how to address the gap of the test coverage.

Another example (e.g., example 28) relates to a previously described example (e.g., one of the examples 15 to 27) or to any of the examples described herein, further comprising that the means is configured to execute unit tests corresponding to the plurality of test vectors based on the test specification.

An example (e.g., example 29) relates to a method for generating a test specification for testing software code of a function under test, the method comprising extracting (110) a plurality of symbols from the software code of the function under test. The method comprises generating (130) a plurality of test vectors with corresponding sets of expected results for the function under test based on the plurality of symbols. The method comprises generating (180) a test specification based on the plurality of test vectors and the corresponding sets of expected results.

Another example (e.g., example 30) relates to a previously described example (e.g., example 29) or to any of the examples described herein, further comprising that the method comprises identifying (120) one or more branch symbols and one or more condition symbols among the plurality of symbols and generating (130) the plurality of test vectors based on branching outcomes of the one or more branch symbols and/or based on condition outcomes of the one or more condition symbols.

Another example (e.g., example 31) relates to a previously described example (e.g., one of the examples 29 to 30) or to any of the examples described herein, further comprising that the plurality of symbols are extracted from an output of a compiler for compiling the software code of the function under test.

Another example (e.g., example 32) relates to a previously described example (e.g., one of the examples 29 to 31) or to any of the examples described herein, further comprising that each set of expected results comprises one or more of an expected invocation of one or more functions, an expected memory layout, an expected return value of the function under test, and an expected impact of the function under test on global memory or an external resource.

Another example (e.g., example 33) relates to a previously described example (e.g., example 32) or to any of the examples described herein, further comprising that the method comprises including (185) one or more of information on one or more dummy functions representing the one or more functions, information on the expected memory layout, information on the expected return value of the function under test, and information on the expected impact of the function under test on the global memory or the external resource in the test specification.

Another example (e.g., example 34) relates to a previously described example (e.g., one of the examples 32 to 33) or to any of the examples described herein, further comprising that the expected memory layout is based on one or more local variables and/or memory structures included in the software code.

Another example (e.g., example 35) relates to a previously described example (e.g., one of the examples 29 to 34) or to any of the examples described herein, further comprising that each set of expected results comprises an expected invocation of one or more functions, wherein the method comprises generating (140) information on one or more dummy functions representing the one or more functions, the information on the one or more dummy functions comprising information on a return value and an expected impact on global memory or an external resource of the respective one or more dummy functions and, if more than one dummy function is generated, information on a sequence of invocation of the dummy functions, the method further comprising including (185) the information on the one or more dummy functions in the test specification.

Another example (e.g., example 36) relates to a previously described example (e.g., one of the examples 29 to 35) or to any of the examples described herein, further comprising that the test specification comprises a specification of a plurality of unit tests that are based on the plurality of test vectors and the plurality of expected results.

Another example (e.g., example 37) relates to a previously described example (e.g., one of the examples 29 to 36) or to any of the examples described herein, further comprising that the method comprises recursively traversing (135) the symbols of the plurality of symbols to generate the plurality of test vectors.

Another example (e.g., example 38) relates to a previously described example (e.g., example 37) or to any of the examples described herein, further comprising that the method comprises determining (150) a test coverage of the plurality of test vectors while traversing the symbols and identifying (155) a coverage gap in the test coverage.

Another example (e.g., example 39) relates to a previously described example (e.g., example 38) or to any of the examples described herein, further comprising that the method comprises generating (160) code for addressing the gap of the test coverage and integrating (165) the code for addressing the gap of the test coverage in the software code.

Another example (e.g., example 40) relates to a previously described example (e.g., example 38) or to any of the examples described herein, further comprising that the method comprises providing (170) information for addressing the gap of the test coverage in the software code or by customizing the coverage.

Another example (e.g., example 41) relates to a previously described example (e.g., example 40) or to any of the examples described herein, further comprising that the method comprises providing (170) the information for addressing the gap of the test coverage as part of a code advisor for guiding a user on how to address the gap of the test coverage.

Another example (e.g., example 42) relates to a previously described example (e.g., one of the examples 29 to 41) or to any of the examples described herein, further comprising that the method comprises executing (190) unit tests corresponding to the plurality of test vectors based on the test specification.

An example (e.g., example 43) relates to a machine-readable storage medium including program code, when executed, to cause a machine to perform the method of one of the examples 29 to 42.

An example (e.g., example 44) relates to a computer program having a program code for performing the method of one of the examples 29 to 42 when the computer program is executed on a computer, a processor, or a programmable hardware component.

An example (e.g., example 45) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for generating a test specification for testing software code of a function under test, the apparatus comprising interface circuitry and processing circuitry to:
extract a plurality of symbols from the software code of the function under test;
generate a plurality of test vectors with corresponding sets of expected results for the function under test based on the plurality of symbols; and
generate a test specification based on the plurality of test vectors and the corresponding sets of expected results.

2. The apparatus according to claim 1, wherein the processing circuitry is to identify one or more branch symbols and one or more condition symbols among the plurality of symbols, and to generate the plurality of test vectors based on branching outcomes of the one or more branch symbols and/or based on condition outcomes of the one or more condition symbols.

3. The apparatus according to claim 1, wherein the plurality of symbols are extracted from an output of a compiler for compiling the software code of the function under test.

4. The apparatus according to claim 1, wherein each set of expected results comprises one or more of an expected invocation of one or more functions, an expected memory layout, an expected return value of the function under test, and an expected impact of the function under test on global memory or an external resource.

5. The apparatus according to claim 4, wherein the processing circuitry is to include one or more of information on one or more dummy functions representing the one or more functions, information on the expected memory layout, information on the expected return value of the function under test, and information on the expected impact of the function under test on the global memory or the external resource in the test specification.

6. The apparatus according to claim 4, wherein the expected memory layout is based on one or more local variables and/or memory structures included in the software code.

7. The apparatus according to claim 1, wherein each set of expected results comprises an expected invocation of one or more functions, wherein the processing circuitry is to generate information on one or more dummy functions representing the one or more functions, the information on the one or more dummy functions comprising information on a return value and an expected impact on global memory or an external resource of the respective one or more dummy functions and, if more than one dummy function is generated, information on a sequence of invocation of the dummy functions, and to include the information on the one or more dummy functions in the test specification.

8. The apparatus according to claim 1, wherein the test specification comprises a specification of a plurality of unit tests that are based on the plurality of test vectors and the plurality of expected results.

9. The apparatus according to claim 1, wherein the processing circuitry is to recursively traverse the symbols of the plurality of symbols to generate the plurality of test vectors.

10. The apparatus according to claim 9, wherein the processing circuitry is to determine a test coverage of the plurality of test vectors while traversing the symbols, and to identify a coverage gap in the test coverage.

11. The apparatus according to claim 10, wherein the processing circuitry is to generate code for addressing the gap of the test coverage and to integrate the code for addressing the gap of the test coverage in the software code.

12. The apparatus according to claim 10, wherein the processing circuitry is to provide information for addressing the gap of the test coverage in the software code or by customizing the coverage.

13. The apparatus according to claim 12, wherein the processing circuitry is to provide the information for addressing the gap of the test coverage as part of a code advisor for guiding a user on how to address the gap of the test coverage.

14. The apparatus according to claim 1, wherein the processing circuitry is to execute unit tests corresponding to the plurality of test vectors based on the test specification.

15-16. (canceled)

17. A method for generating a test specification for testing software code of a function under test, the method comprising:
extracting a plurality of symbols from the software code of the function under test;
generating a plurality of test vectors with corresponding sets of expected results for the function under test based on the plurality of symbols; and
generating a test specification based on the plurality of test vectors and the corresponding sets of expected results.

18. The method according to claim 17, further comprising identifying one or more branch symbols and one or more condition symbols among the plurality of symbols and generating the plurality of test vectors based on branching outcomes of the one or more branch symbols and/or based on condition outcomes of the one or more condition symbols.

19. The method according to claim 18, wherein each set of expected results comprises an expected invocation of one or more functions, wherein the method comprises generating information on one or more dummy functions representing the one or more functions, the information on the one or more dummy functions comprising information on a return value and an expected impact on global memory or an external resource of the respective one or more dummy functions and, if more than one dummy function is generated, information on a sequence of invocation of the dummy functions, the method further comprising including the information on the one or more dummy functions in the test specification.

20. The method according to claim 18, wherein the method comprises recursively traversing the symbols of the plurality of symbols to generate the plurality of test vectors.

21. The method according to claim 17 wherein the method comprises determining a test coverage of the plurality of test vectors while traversing the symbols and identifying a coverage gap in the test coverage.

22-24. (canceled)

25. A machine-readable storage medium including program code, when executed, to cause a machine to perform the method of claim 17.
